(19) United States
(12) Patent Application Publication
(10) Pub. No.: US 2013/0315257 A1
(43) Pub. Date: Nov. 28, 2013

(54) ENERGY EFFICIENT ROUTING AND SWITCHING

(71) Applicants: Annikki Welin, Solna (SE); Tomas Thyni, Jarfalla (SE)

(72) Inventors: Annikki Welin, Solna (SE); Tomas Thyni, Jarfalla (SE)

(73) Assignee: Telefonaktiebolaget L M Ericsson (publ), Stockholm (SE)

(21) Appl. No.: 13/995,868

(22) PCT Filed: Dec. 20, 2010
(86) PCT No.: PCT/SE2010/000308

§ 371 Date: Aug. 1, 2013

(51) Int. Cl. H04L 12/733

(52) U.S. Cl. CPC H04L 45/122
USPC 370/401

(57) ABSTRACT

This invention relates to a method and a node for energy efficient routing and switching in a communication network. When determining the best path from an originating node to a destination node, current routing or switching protocols use route selection metrics based on the bandwidth of the link interface. Certain paths are however consuming more power that others which can result in traffic flowing over a high power consuming and long distance path, because this is the best path based on the existing metrics. The present invention overcomes this by introducing a node and a method to switch data also using energy consumption metrics. These metrics can be based on the power consumption in link interfaces, the links and in the node.

### TECHNICAL FIELD

The present invention relates to a method and a node for energy efficient routing and switching in a communication network.

### BACKGROUND

A number of different routing and switching protocols for switching data in a communication network exists today. The routing protocols can be divided into two broad groups of protocols, link state routing protocols and distance vector routing protocols. Examples of link state routing protocols are OSPF (Open Shortest Path First) and IS-IS (Intermediate system to intermediate system). OSPF is defined in IETF RFC 2328 Version 2 for IPv4 and IETF RFC 5340 for IPv6. An example on a distance vector routing protocol is IGRP, Interior Gateway Routing Protocol.

To help a router to determine the best path among multiple paths to a destination, routing metrics are used. Routing metrics are typically based on information like path length, bandwidth, load, hop count, path cost, delay, etc. Routing metrics are normally stored in a routing table in each router so it can take a routing decision.

A routing protocol that does not use routing decisions in each node is the source routing protocol. In this protocol a path between an originating node and a destination node is calculated and configured in advance. Each node stores a list of the other nodes involved in the path. As the path through the network is already known beforehand by the originating node, a packet sent from the originating node comprises a list of all nodes it must pass until the packet reaches the destination node.

The installed base of routing or switching protocols does however not take into account the energy consumption required for different paths in a network. This can result in traffic flowing over a high power consuming and long distance path, because it is the best path based on the existing metrics (often being the link bandwidth).

Energy aware routing has been discussed in the paper ‘Experiments with Energy Saving Dynamic Source Routing’ by Diana Fang et al. This paper discloses a method for source routing in a wireless ad hoc sensor network. Nodes in this kind of network are often remotely located and battery operated. In some applications the nodes are powered by solar panels. The energy input from the solar panels depends on the time of day, weather conditions and so on. The routing discussed in this paper is therefore focused on how to avoid routing packets via nodes that for the moment are low on power.

A disadvantage with this method is that it is not guaranteed that the path consuming the least energy is selected. Another disadvantage is that the method only considers the energy consumption for the nodes as a total and not for individual links between the nodes. In a core network with router and/or switch nodes, a number of different links can be connected between the nodes and link interfaces with different energy consumption can coexist in the same node.

Yet another problem is that the route maintenance in source routing protocols does not locally repair a broken link, whereas this is quickly handled in link-state protocols such as OSPF.

### SUMMARY

With this background, it is the object of the present invention to obviate at least some of the disadvantages mentioned above.

The present invention comprises a method for switching data packets in a node comprising the steps of firstly allocating route selection metrics to the link interfaces in the node where the route selection metrics at least comprise energy consumption metrics. Route selection metrics concerning link interfaces in a plurality of other nodes belonging to the same routing area are received. A best path to all possible destination nodes in the communication network is determined based on at least the energy consumption metrics and stored in a routing table. When receiving a request to send a packet to a specific destination node, the node selects from the routing table the link interface connected to the link belonging to the best path to the specific destination node from an energy consumption point of view. After selecting the link interface, the packet is sent towards the destination node via the selected link interface. Optionally, the node sends the allocated energy consumption metrics in the node to the other nodes in the same routing area.

The node itself comprises at least one link interface adapted to be allocated route selection metrics comprising energy consumption metrics and to receive route selection metrics concerning link interfaces in a plurality of other nodes belonging to the same routing area as the first node. The node also comprises a route control unit which is adapted to determine best paths to destination nodes in the communication network based on at least the energy consumption metrics.

The node further comprises a routing table accessible by the route control unit and adapted to store the best paths.

When the node receives a request to send a packet to a specific destination node, the route control unit selects a link interface connected to a link belonging to the best path from an energy consumption point of view. After selecting the link interface, the node sends the packet towards the specific destination node via the selected link interface.

An advantage with the present invention is that the node can be configured to always select the path with the lowest power consumption, and this reduces the energy cost for the network provider and lowers the overall CO2 pressure.

Another advantage of the present invention is that a number of different power consumption factors can be taken into account, such as the power consumption for the interfaces, portions of the node's total power consumption and the power consumption of the communication links which can vary depending on many factor such as speed, distance, transport technologies (uW, xWDM, OTN, SDH etc).

Another advantage is that the concept of the present invention is not limited to routing protocols as OSPF, ISIS etc but is also applicable when establishing Label Switch Paths (LSPs) in MPLS or GMPLS and for wavelength routing. Moreover, the invention can be implemented relatively easy in existing routers or switches.

Yet another advantage is that the routing protocols can load-balance the communication over multiple paths if they have the equal energy consumption metrics.

The option of sending the allocated energy consumption metrics to the other nodes in the same routing area further improves the traffic engineering possibilities in the network.

The invention will now be described in more detail and with preferred embodiments and referring to accompanying drawings.

### BRIEF DESCRIPTION OF THE DRAWINGS

FIGS. 1A and 1B are block diagrams showing routing according to prior art.

FIGS. 2A and 2B are block diagrams showing routing according to the present invention.

FIG. 3 is a block diagram showing a node according to the present invention.

FIG. 4 is a flow chart showing the steps of routing according to the present invention.

### DETAILED DESCRIPTION

The router or switch node and the routing or switching method in the present invention can for example be applied to link-state routing protocols such as OSPF (Open Shortest Path First). In link-state protocols, each node in a communication network constructs a map over the connectivity to the network in the form of a graph, showing which nodes are connected to which other nodes. Each node then independently calculates the best path from it to every possible destination in the network. The collection of best paths will then form the node's routing table. The nodes are connected to each other with communication links. The information about the status of a link, the link-state, is maintained in each router as a link-state database (LSDB) which is a tree-image of the entire network topology. Identical copies of the LSDB are periodically updated through flooding on all OSPF routers.

The OSPF routing policies to construct a routing table are governed by link cost factors (metrics) associated with each routing link interface. Cost factors may be the distance of a router (round-trip time), network throughput of a link (such as bandwidth), or link availability and reliability.

This also provides a dynamic process of traffic load balancing between routes of equal cost.

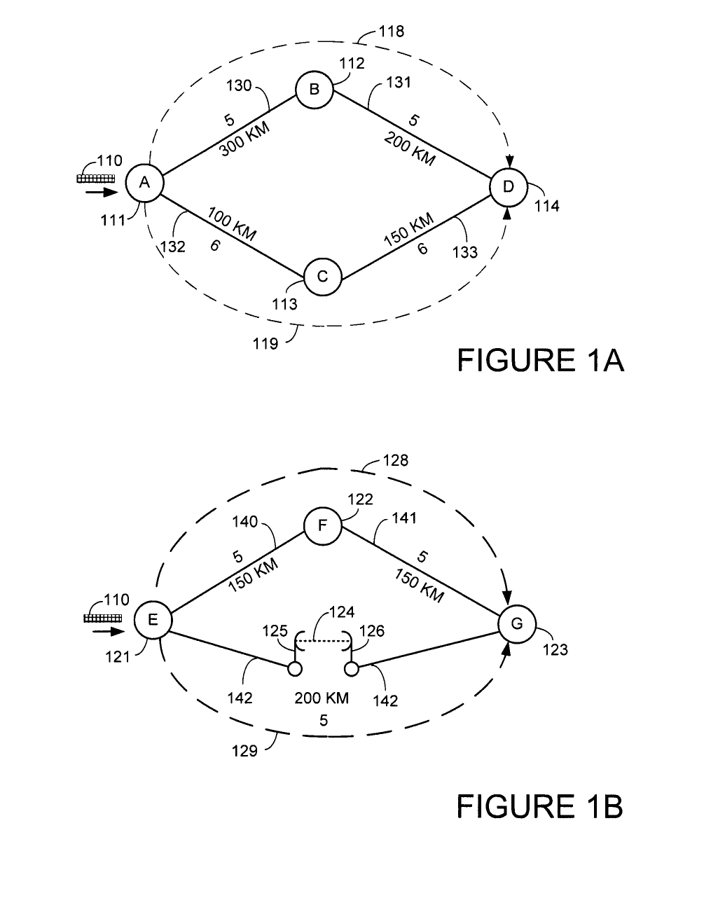

FIG. 1A illustrates a simple example of a typical routing situation involving four switching or routing nodes A,B,C,D 111-114 in a communication network. A data packet 110 is received by node A 111 from another node in the network (not shown) or as a protocol primitive from a client within the node A 111 itself. The packet 110 is to be sent to node D 114. When node A 111 receives the packet 110 it has to make a route decision whether to route the packet 110 over node B 112 or node C 113. Although different routing metrics have been specified in the OSPF standard, the most used metric is the one determined by the speed (bandwidth) of the link interface. Some vendors use a formula to calculate the metric by dividing a reference bandwidth (such as 100 Mb/s) with the bandwidth of the link interface. If for example the link interface bandwidth is 10 Mb/s, the metric gets the value ‘10’. In FIG. 1A, there are two possible paths to reach node D 114 from node A 111. In the first path A-B-D 118 the link interface in node A 110 connected to the 300 km link 130 between A-B has been allocated the metric ‘5’ and the link interface in node B 112 connected to the 200 km link 131 between B-D has also been allocated the metric ‘5’. In the second path A-C-D 119 the link interface in node A 110 connected to the 100 km link 132 between A-C has been allocated the metric ‘6’ and the link interface in node C 113 connected to the 150 km link 133 between C-D has also been allocated the metric ‘6’.

When node A 111 makes the routing decision it will select the link interface connected to the link belonging to the best path. In this case the best path is path 118 because path 118 has the metrics 5+5=10 whereas path 119 has the metrics 6+6=12.

The example in FIG. 1A does not take into account the energy consumption for the different paths. If the links 130-133 between the nodes are all optical (fiber), the 300 km+200 km long path 118 consumes more energy in the link interfaces than the 100 km+150 km path 119. But according to the existing metrics, path 118 is selected as this is the best path from a bandwidth point of view.

Another example is shown in FIG. 1B. In this figure, a packet 110 is to be sent from a node E 121 to a node G 123. One possible path 128 comprises a 150 km optical link 140 between node E 121 and an intermediate node F 122 and a 150 km optical link 141 between node F 122 and the destination node G 123. Path 128 has the metrics 10 (5+5). The other possible path 129 uses a direct link 142 between node E 121 and node G 123 having the metrics 5.

Again, using existing metrics, path 129 would have been chosen as it has the lowest metrics 5 as opposed to path 128 that has the metrics 10 (5+5). However, a part of the direct link 142 goes via a radio link 124. This radio link 124 requires additional network elements such as radio link transceivers 125, 126. These network elements 125, 126 do only relay the packet 110 and are not involved in the routing decisions. However being separate network elements having their own power feed they considerably contribute to the total energy consumption.

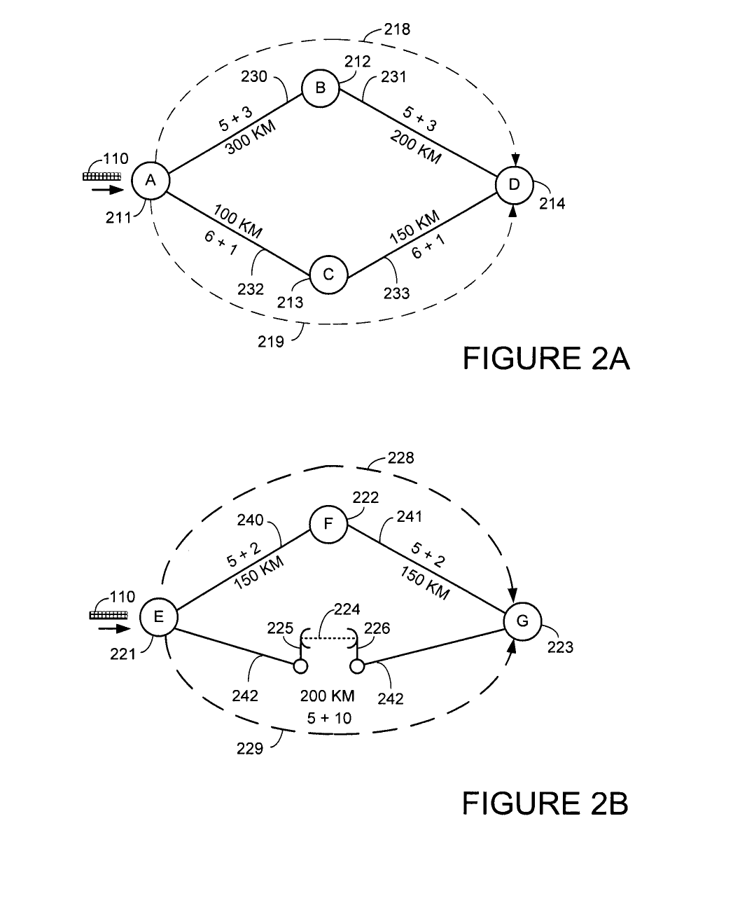

FIGS. 2A and 2B illustrates the same network scenario as in FIGS. 1A and 1B. The difference is that the link interfaces now include allocated routing metrics according to the present invention.

In FIG. 2A, the link interface in node A 211 connected to the link 230 has been allocated extra energy consumption metrics of 3 and the link interface in node B 212 has been allocated extra energy consumption metrics of 3 as well. This means that path 218 now has the total metrics of 16 (5+3+5+3). Correspondingly, the link interface in node A 110 connected to the link 232 has been allocated extra energy consumption metrics of 1 and the link interface in node C 213 connected to the link 233 has been allocated extra energy consumption metrics of 1 as well. This means that path 219 now has the total metrics of 14 (6+1+6+1).

When node A 211 receives packet 110 aimed for the destination node D 214, it will select the link interface connected to the link belonging to the best path from an energy consumption point of view which in this case is path 219.

In FIG. 2B, the link interface in node E 221 connected to the link 240 has been allocated extra energy consumption metrics of 2 and the link interface in node F 222 connected to link 241 has been allocated extra energy consumption metrics of 2 as well. This means that path 228 now has the total metrics of 14 (5+2+5+2). Correspondingly, the link interface in node E 221 connected to the link 242 has been allocated extra energy consumption metrics of 10 which means the total metrics for path 229 is 15 (5+10).

When node E 221 receives packet 110 aimed for the destination node G 223 it will select the link interface connected to the link belonging to the best path which in this case is path 228.

In the network scenarios in FIGS. 2A and 2B the metrics combine bandwidth and energy consumption. It is however possible to use energy consumption metrics alone.

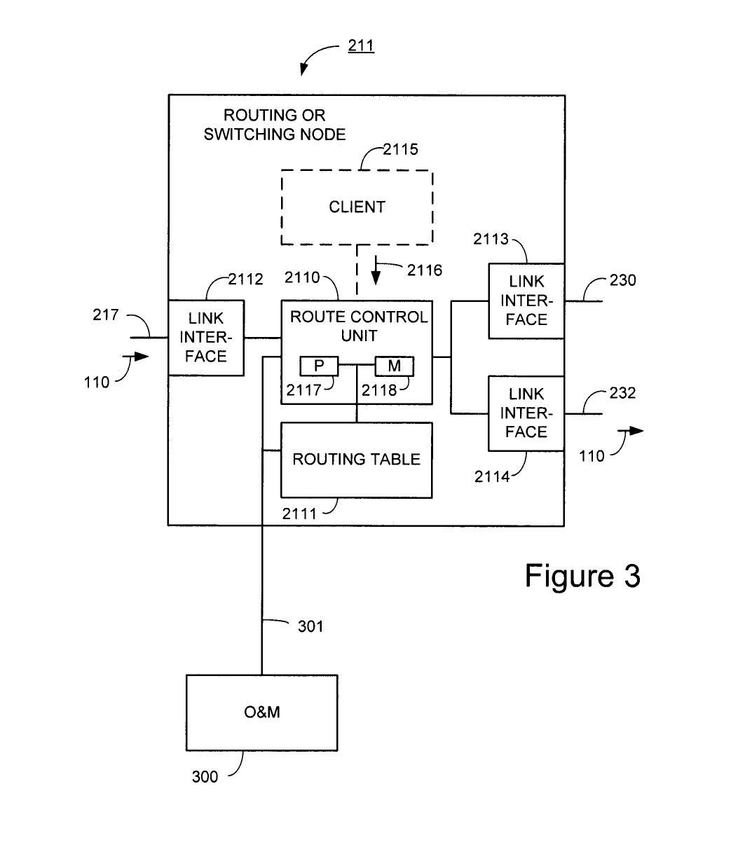

FIG. 3 illustrates an embodiment of a node 211 adapted for energy efficient routing or switching according to the present invention. The node 211 in FIG. 3 comprises three link interfaces 2112,2113,2114 each connected to a link 217,230,232. The link interfaces are adapted to be allocated route selection metrics including energy consumption metrics. The link interfaces 2112,2113,2114 are connected to a router control unit 2110. This route control unit 2110 makes the routing decisions and calculates the best paths to different destinations in the communication network. The best paths are stored in a routing table 2111 which is accessible by the route control unit 2110. The route control unit 2110 is preferable implemented as a processor P 2117 with a memory area M 2118 comprising executable code adapted to perform the functions described above and below. The route selection metrics including energy consumption metrics can for example be stored in the memory area 2118 or in the routing table 2111. The route selection metrics are allocated from an O&M center 300 through an operation and management interface 301 in the node 211. The link interfaces 2112,2113,2114 are adapted to receive and send data packets and also routing protocol packets (for example according to the OSPF or the IS-IS protocol). The link interfaces 2112,2113,2114 can for example receive route selection metrics concerning link interfaces from other nodes 212,213 belonging to the same routing area. The route selection metrics (optionally including energy consumption metrics) are received in link state advertisement messages LSA. When the link interfaces 2112,2113,2114 in node 211 are allocated energy consumption metrics, the node 211 may optionally send these metrics in link state advertisement messages to the other nodes 212,213 in the same routing area.

The basic functionality of node 211 is to receive packets 110 from nodes in the communication network and to route these packets 110 further to other nodes 212,213. It is also possible that the node itself comprises a client 2115 that can originate and terminate data packets. A request to send a packet can therefore also be received by the route control unit 2110 as a protocol primitive 2116 from the client 2115.

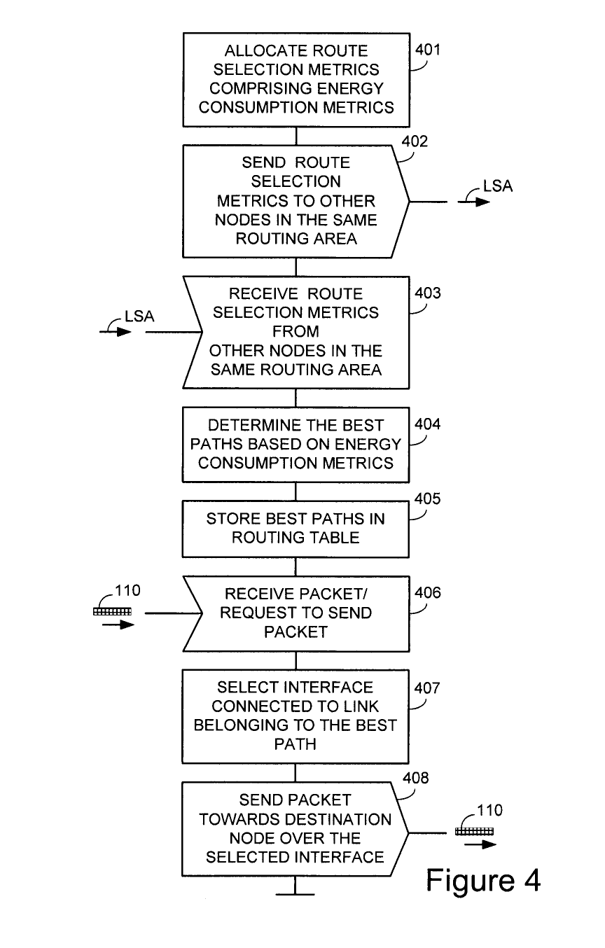

The method to switch packets from an originating node to a destination node according to the present invention is illustrated by a flow chart in FIG. 4. Route selection metrics comprising energy consumption metrics are allocated in step 401 to the link interfaces 2112,2113,2114 in node 211.

Optionally in step 402, the node 211 sends these route selection metrics in link state advertisement messages LSAs to other nodes 212,213 belonging to the same routing area. For the routing protocols the energy consumption metrics can be seen as extensions to OSPF traffic engineering as specified in RFC2370 or to MPLS traffic engineering as specified in RFC2702.

The node 211 receives in step 403 LSAs with route selection metrics concerning link interfaces in other nodes belonging to the same routing area. These route selection metrics could optionally also comprise the energy consumption metrics concerning these link interfaces.

With the route metrics available, best paths 218,219 to all possible destination nodes in the communication network are determined in step 404 based on at least the allocated energy consumption metrics. The best paths 218,219 are in step 405 stored in the routing table 2111.

When receiving in step 406 a request to send a packet 110 to a specific destination node 214, the route control unit 2110 selects in step 407 from the routing table 2111 a link interface 2114 connected to a link 232 belonging to the best path 219 to the specific destination node 214. After the selection, the packet 110 is sent in step 408 towards the specific destination node 214 via the selected link interface 2114.

Again, the data packet 110 could be received from another node in the network (not shown) or as a protocol primitive 2116 from the client 2115 within the node 211 itself.

The energy consumption metrics is defined as a power consumption factor divided by the speed (bandwidth) for the link interface. The energy consumption metrics can for example be expressed by the unit watt/bits/s, watt/Gbit/s or nJ/bit.

The power consumption factor allocated to an individual link interface could be determined by measurements or if already known for example by data sheets for the link interfaces.

The power consumption factor can be different for different types of link interfaces but also for link interfaces of the same type but implemented differently (different micro processors etc) or coming from different vendors.

As already touched upon above, the power consumption factor allocated to an individual link interface 2113, 2114 is not necessarily limited to the power consumption by the link interface 2113, 2114 itself. It could also be based on a number of other factors or combinations thereof. The power consumption factor could be based on a portion of the power consumption of the whole node 211. It can also be based on the power consumption by the link 230, 232 connected to the link interface 2113, 2114. For direct fiber or copper links the power is normally fed from the link interfaces. But when the link comprises other network elements with own power feeding, such as intermediate cross connects, relay bridges, radio links, satellites etc the power consumption for the link is a significant factor.

1. A method in a first node (211) for switching data packets (110) from a source node to a destination node (214) in a communication network the method characterized by the steps of:
allocating (401) route selection metrics comprising energy consumption metrics to at least one link interface (2114) in the first node (211);
receiving (403) route selection metrics concerning link interfaces in a plurality of other nodes (212,213) belonging to the same routing area as the first node (211);
determining (404) the best paths to all possible destination nodes in the communication network based on at least the energy consumption metrics;
storing (405) the best paths in a routing table (2111);
receiving (406) a request to send a packet (110) to a specific destination node (214);
selecting (407) from the routing table (2111) a link interface (2114) connected to a link (232) belonging to the best path (219) to the specific destination node (214);
sending (408) the packet (110) towards the specific destination node (214) over the selected link interface (2114).

2. A method as in claim 1 where the step (403) of receiving route selection metrics for the link interfaces from the other nodes (212,213) also includes the reception of energy consumption metrics concerning link interfaces in the other nodes (212,213).

3. A method as in claim 2 further comprising the step of sending (402) the allocated energy consumption metrics to each one of the other nodes (212,213).

4. A method as in claim 3 where the energy consumption metrics are sent and received in link state advertisement messages.

5. A method as in claim 1 where the step (401) of allocating the energy consumption metrics for the link interface (2114) includes the activity of allocating a power consumption factor for the link interface (2114).

6. A method as in claim 5 where the allocated energy consumption metrics are defined as the allocated power consumption factor divided by the link speed for the link interface (2114).

7. A method as in claim 6 where the allocated power consumption factor is based on any or on any combination of:
the power consumption by the link interface (2114);
a portion of the power consumption by the first node (211);
the power consumption by the link (232) connected to the link interface (2114).

8. A method as in any preceding claim where the energy consumption metrics are configured through an operation and management interface (301) in the first node (211).

9. A method as in any preceding claim where the first node (211) equals the originating node and where the request to send a packet is received as a protocol primitive (2116) within the first node (211).

10. A first node (211) for switching data packets from an originating node to a destination node (214) in a communication network the first node (211) comprising:
at least one link interface (2114) adapted to be allocated route selection metrics and to receive route selection metrics concerning link interfaces in a plurality of other nodes (212,213) belonging to the same routing area as the first node (211);
a route control unit (2110) adapted to determine best paths (218,219) to destination nodes (214) in the communication network based on the route selection metrics;
a routing table (2111) accessible by the route control unit (2110) adapted to store the best paths;
and where the first node (211) is characterized in that the at least one link interface (2114) is further adapted to be allocated energy consumption metrics and where the route control unit (2110) is further adapted to determine the best paths (218,219) based at least on the energy consumption metrics so that when the first node (211) receives a request to send a packet (110) to a specific destination node (214), the route control unit (2110) selects a link interface (2114) connected to a link (232) belonging to the best path (219) to the specific destination node (214) and the first node (211) sends the packet (110) towards the specific destination node (214) over the selected link interface (2114).

11. A first node (211) as in claim 10 where the at least one link interface (2114) is further adapted to receive route selection metrics comprising energy consumption metrics concerning the link interfaces in the plurality of other nodes (212,213) and to send the allocated energy consumption metrics to the other nodes (212,213).

12. A first node (211) as in claim 11 where the energy consumption metrics are sent and received in link state advertisement messages.

13. A first node (211) as in claim 12 where the energy consumption metrics are defined as an allocated power consumption factor divided by the link speed for the link interface (2114).

14. A first node (211) as in any of the claims 10 to 13 further comprising an operation and management interface (301) through which energy consumption metrics are allocated.
